(19) United States
(12) Patent Application Publication
(10) Pub. No.: US 2019/0078363 A1
(43) Pub. Date: Mar. 14, 2019

(54) Temporary Door Barricade Assembly

(71) Applicant: Erick Keyser, Harrisburg, OH (US)

(72) Inventor: Erick Keyser, Harrisburg, OH (US)

(21) Appl. No.: 15/703,471

(22) Filed: Sep. 13, 2017

(51) Int. Cl. E05C 19/18; E05C 19/00

(52) U.S. Cl. CPC E05C 19/184; E05C 19/003

(57) ABSTRACT

A temporary door barricade assembly for temporarily locking a door includes a barricade that is selectively extended across a doorway. A receiver is coupled to the barricade. The receiver engages a door knob on the door when the barricade is positioned across the doorway. Moreover, the barricade abuts the doorway when an individual tries to open the door. In this way the barricade inhibits the door from being opened.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to barricade devices and more particularly pertains to a new barricade device for temporarily locking a door.

### BRIEF SUMMARY OF THE INVENTION

An embodiment of the disclosure meets the needs presented above by generally comprising a barricade that is selectively extended across a doorway. A receiver is coupled to the barricade. The receiver engages a door knob on the door when the barricade is positioned across the doorway. Moreover, the barricade abuts the doorway when an individual tries to open the door. In this way the barricade inhibits the door from being opened.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a temporary door barricade assembly according to an embodiment of the disclosure.

FIG. 2 is a top perspective in-use view of an embodiment of the disclosure.

FIG. 3 is a front view of an embodiment of the disclosure.

FIG. 4 is a perspective in-use view of an embodiment of the disclosure.

### DETAILED DESCRIPTION OF THE INVENTION

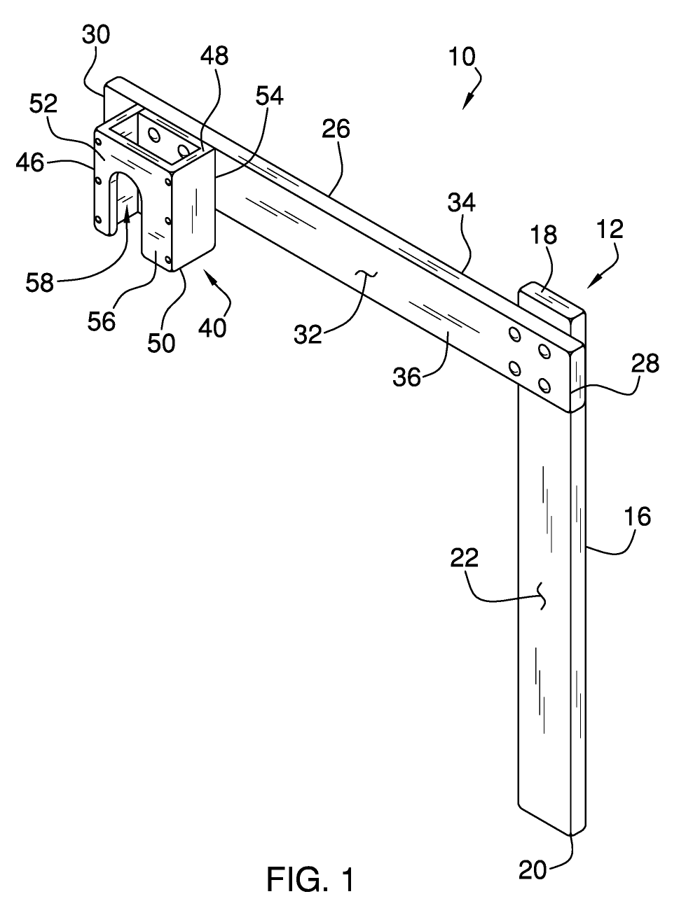

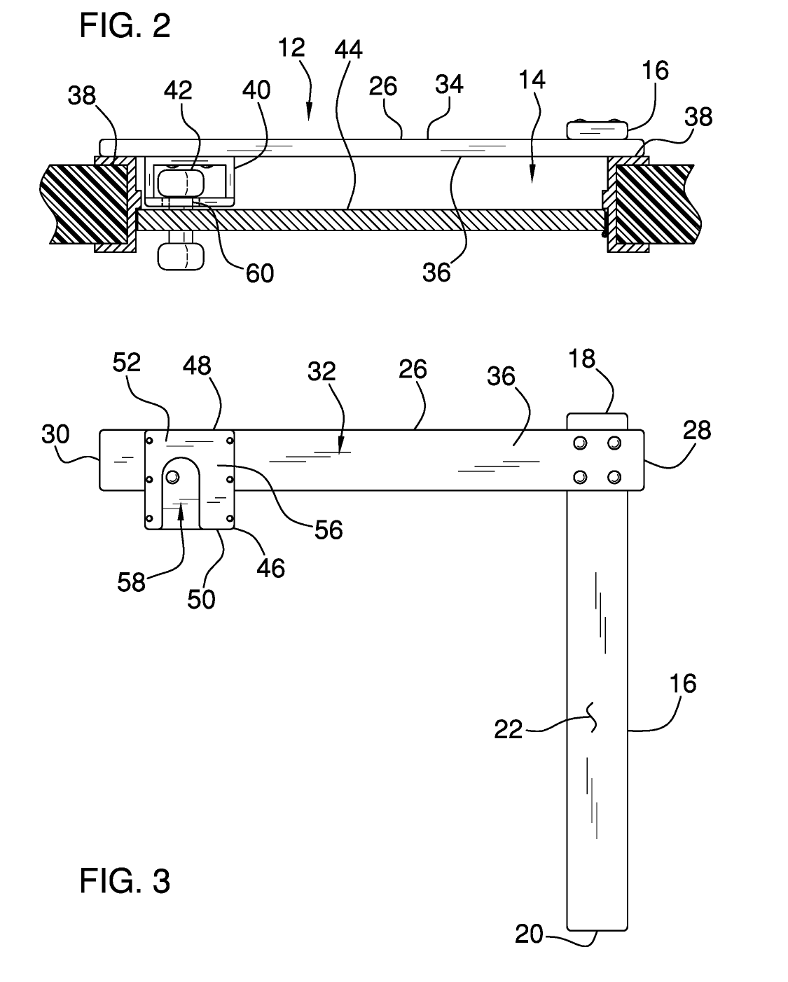

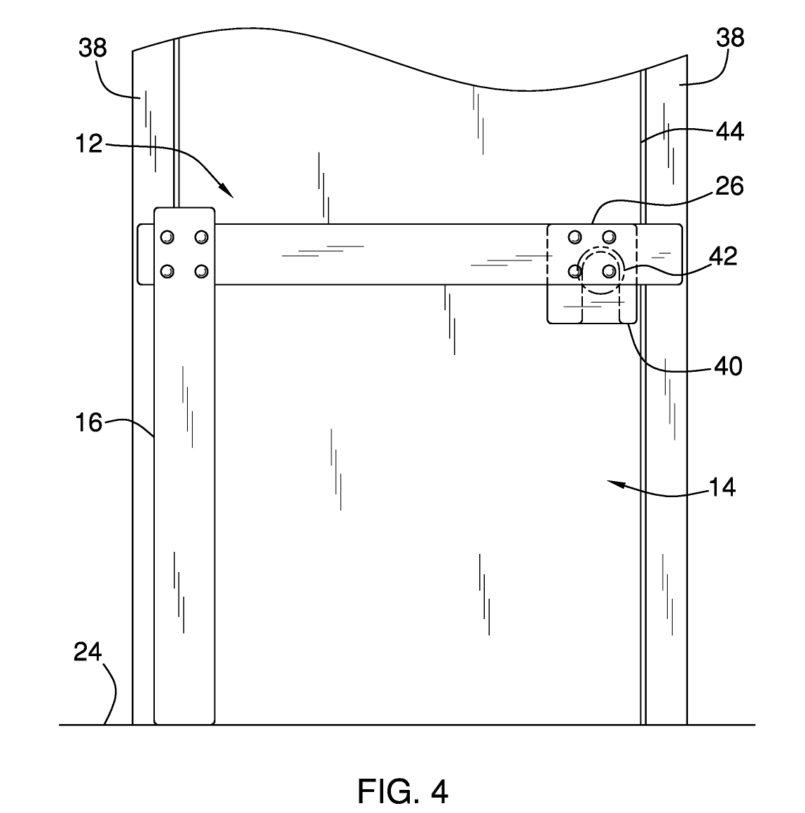

With reference now to the drawings, and in particular to FIGS. 1 through 4 thereof, a new barricade device embodying the principles and concepts of an embodiment of the disclosure and generally designated by the reference numeral 10 will be described.

As best illustrated in FIGS. 1 through 4, the temporary door barricade assembly 10 generally comprises a barricade 12 that is selectively extended across a doorway 14. The doorway 14 may be a doorway 14 into a classroom in a school or other public building. The barricade 12 comprises a first member 16 that has a first end 18, a second end 20 and a first surface 22 extending therebetween. The first end 18 is positioned on a support surface 24 having the first member 16 being vertically oriented. Additionally, the first member 16 is aligned with the doorway 14.

A second member 26 is provided that has a primary end 28, a secondary end 30 an outer surface 32 extending therebetween. The outer surface 32 has a forward side 34 and a rearward side 36. The forward side 34 is coupled to the first surface 22 of the first member 16 having the second member 26 being oriented perpendicular with respect to the first member 16. Moreover, the primary end 28 is aligned with the first end 18. Thus, the second member 26 extends horizontally across the doorway 14 when the first member 16 is positioned on the support surface 24. The forward side 34 of the second member 26 abuts each of a pair of door jambs 38 in the doorway 14.

A receiver 40 is coupled to the barricade 12. The receiver 40 engages a door knob 42 on a door 44 when the barricade 12 is positioned across the doorway 14. The barricade 12 abuts the doorway 14 when an individual tries to open the door 44. In this way the barricade 12 inhibits the door 44 from being opened.

The receiver 40 comprises a sleeve 46 that has a top end 48, a bottom end 50 and an outer wall 52 extending therebetween. The outer wall 52 has a back side 54 and a front side 56 and the back side 54 is coupled to the rearward side 36 of the second member 26. Moreover, the receiver 40 is positioned closer to the secondary end 30 than the primary end 28 of the second member 26. The front side 56 has a slot 58 extending from the bottom end 50 toward the top end 48. The slot 58 receives a shaft 60 of the door knob 42 having the door knob 42 being positioned between the front side 56 and the back side 54.

In use, the barricade 12 is positioned across the doorway 14 having the doorknob 42 being positioned in the receiver 40 when an emergency occurs. In this way the second member 26 abuts the door jambs 38 when an individual attempts to open the door 44. The individual may be a shooter at a public school and the barricade 12 may be positioned on the doorway 14 by a teacher in a classroom. The barricade 12 inhibits the shooter from opening the door 44 and entering the classroom. Thus, the teacher protects children in the classroom from harm until law enforcement is able to arrive.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A temporary door barricade assembly being configured to selectively inhibit a door from being opened, said assembly comprising:
a barricade being configured to be selectively extend across a doorway; and
a receiver being coupled to said barricade wherein said receiver is configured to engage a door knob on the door, said barricade abutting the doorway when an individual tries to open the door wherein said barricade is configured to inhibit the door from being opened.

2. The assembly according to claim 1, wherein said barricade comprises a first member having a first end, a second end and a first surface extending therebetween, said first end being configured to be positioned on a support surface having said first member being vertically oriented.

3. The assembly according to claim 2, further comprising a second member having a primary end, a secondary end an outer surface extending therebetween, said outer surface having a forward side and a rearward side, said forward side being coupled to said first surface of said first member, said second member being oriented perpendicular with respect to said first member.

4. The assembly according to claim 3, wherein said primary end is aligned with said first end wherein said second member is configured to extend horizontally across the doorway when said first member is positioned on the support surface.

5. The assembly according to claim 3, wherein said receiver comprises a sleeve having a top end, a bottom end and an outer wall extending therebetween, said outer wall having a back side and a front side, said back side being coupled to said rearward side of said second member, said receiver being positioned closer to said secondary end than said primary end of said second member.

6. The assembly according to claim 5, wherein said front side has a slot extending from said bottom end toward said top end wherein said slot is configured to receive a shaft of the door knob having the door knob being positioned between said front side and said back side.

7. A temporary door barricade assembly being configured to selectively inhibit a door from being opened, said assembly comprising:
a barricade being configured to be selectively extended across a doorway, said barricade comprising:
a first member having a first end, a second end and a first surface extending therebetween, said first end being configured to be positioned on a support surface having said first member being vertically oriented,
a second member having a primary end, a secondary end an outer surface extending therebetween, said outer surface having a forward side and a rearward side, said forward side being coupled to said first surface of said first member, said second member being oriented perpendicular with respect to said first member, said primary end being aligned with said first end wherein said second member is configured to extend horizontally across the doorway when said first member is positioned on the support surface; and
a receiver being coupled to said barricade wherein said receiver is configured to engage a door knob on the door, said barricade abutting the doorway when an individual tries to open the door wherein said barricade is configured to inhibit the door from being opened, said receiver comprising a sleeve having a top end, a bottom end and an outer wall extending therebetween, said outer wall having a back side and a front side, said back side being coupled to said rearward side of said second member, said receiver being positioned closer to said secondary end than said primary end of said second member, said front side having a slot extending from said bottom end toward said top end wherein said slot is configured to receive a shaft of the door knob having the door knob being positioned between said front side and said back side.
